(19) United States
(12) Patent Application Publication
(10) Pub. No.: US 2011/0083532 A1
(43) Pub. Date: Apr. 14, 2011

(54) PROCESS FOR INCREASING DROSS RECOVERIES

(75) Inventor: David J. Roth, Downingtown, PA (US)

(73) Assignee: ALTEK, L.L.C., Exton, PA (US)

(21) Appl. No.: 12/883,486

(22) Filed: Sep. 16, 2010

Related U.S. Application Data
(60) Provisional application No. 61/249,727, filed on Oct. 8, 2009.

(51) Int. Cl. C22B 5/00; B02C 23/08

(52) U.S. Cl. 75/414; 241/24.25

(57) ABSTRACT

A process for increasing the percentage of metal recovery from dross containing metal particles of different sizes having oxide and salt components adhered thereto. The process includes crushing and tumbling the dross to mechanically remove all of the oxide and salt components from the larger of the metal particles, separating the larger metal particles from the removed oxide and salt components and the smaller metal particles to provide a supply of larger metal particle concentrate, separating the removed oxide and salt components from the smaller metal particles, mechanically impacting the smaller metal particles to remove any additional oxide and salt components from the smaller metal particles, and separating the smaller metal particles from the additional oxide and salt components to provide a supply of smaller metal particle concentrate.

### RELATED APPLICATION DATA

This application claims the benefit of U.S. Provisional Patent Application No. 61/249,727 filed Oct. 8, 2009, the disclosure of which is herein incorporated by reference in its entirety.

### FIELD OF THE INVENTION

This invention relates to a process for increasing the percentage of recovered ferrous or non-ferrous metal concentrates such as aluminum concentrate from certain types of dross.

### SUMMARY OF THE INVENTION

The process of the present invention produces a high percentage of recovered concentrates of aluminum (or other metals) from certain types of dross that can be directly melted in a sidewell or similar type furnace without the use of salt flux.

These high metal content concentrates are obtained in accordance with the present invention by mechanically processing the dross to mechanically separate and remove the oxide and salt components from the metal component while keeping the metal component in its largest particle size possible.

Dross, as used herein, may include solid scum that forms on the surface of a metal when molten or during melting, and is largely the result of oxidation, but may also include a mixture of salt and flux. A common metal that is recoverable using this process is aluminum or aluminum alloys (collectively referred to herein as aluminum). However, such a process can also be used to reclaim other metals from dross containing the metals including magnesium, copper, brass, zinc and certain steel types.

In the case of aluminum, the dross types that particularly lend themselves to this process are primary pressed and non-pressed white dross (i.e., dross that primarily contains aluminum and oxides) pressed and non-pressed black dross (i.e., dross that contains aluminum, oxides and a combination of fluxes), extrusion alloy pressed dross and salt cake.

In accordance with one aspect of the invention, the oxides and salt components and other smaller particles in the dross that are mechanically adhered to the metal component are crushed or crumbled and shaken off from the larger metal particles and screened off to separate the larger metal particle concentrate from the smaller particles.

In accordance with another aspect of the invention, the larger metal particle concentrate is directly fed into a sidewell or similar type furnace for direct melting of the larger metal particle concentrate.

In accordance with another aspect of the invention, the smaller metal particles to which some oxide and salt components may still be adhered are separated from the finer oxides and flux content previously removed for further mechanical processing of the smaller metal particles to remove any remaining oxide and salt components from the smaller metal particles.

In accordance with another aspect of the invention, the smaller metal particle concentrate from which any remaining oxide and salt components have been removed are submersed into the melted larger metal particle concentrate in the sidewell furnace using a suitable submergence system such as a vortex pump or puddling to melt the smaller metal particle concentrate.

In accordance with another aspect of the invention, the remaining fines of oxide and salt components may be further processed for any remaining metal content or other by-product or placed in landfill depending on the economics.

### BRIEF DESCRIPTION OF THE DRAWINGS

FIG. 1 is a block flow diagram showing the process for recovering a high percentage content of metal concentrates from dross in accordance with the present invention.

FIG. 2 is a schematic fragmentary perspective sectional view through one form of rotary lump crusher/reclaimer apparatus that may be used to mechanically separate and remove the oxide and flux salt components from the larger metal particles during the first phase of the dross recycling process of the present invention.

### DETAILED DESCRIPTION OF THE INVENTION

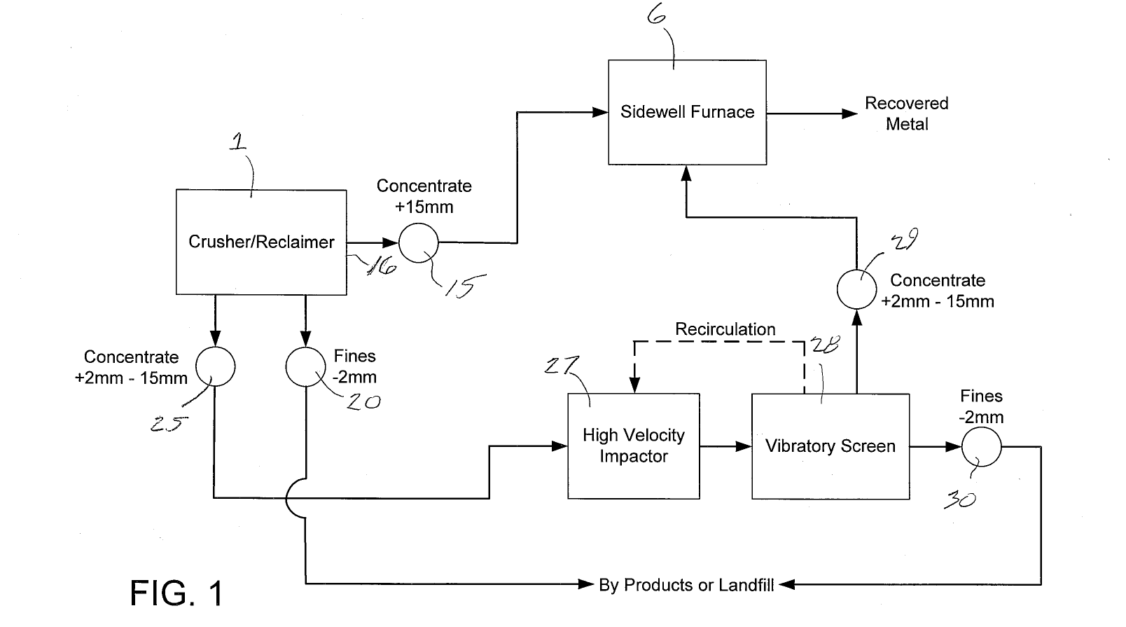

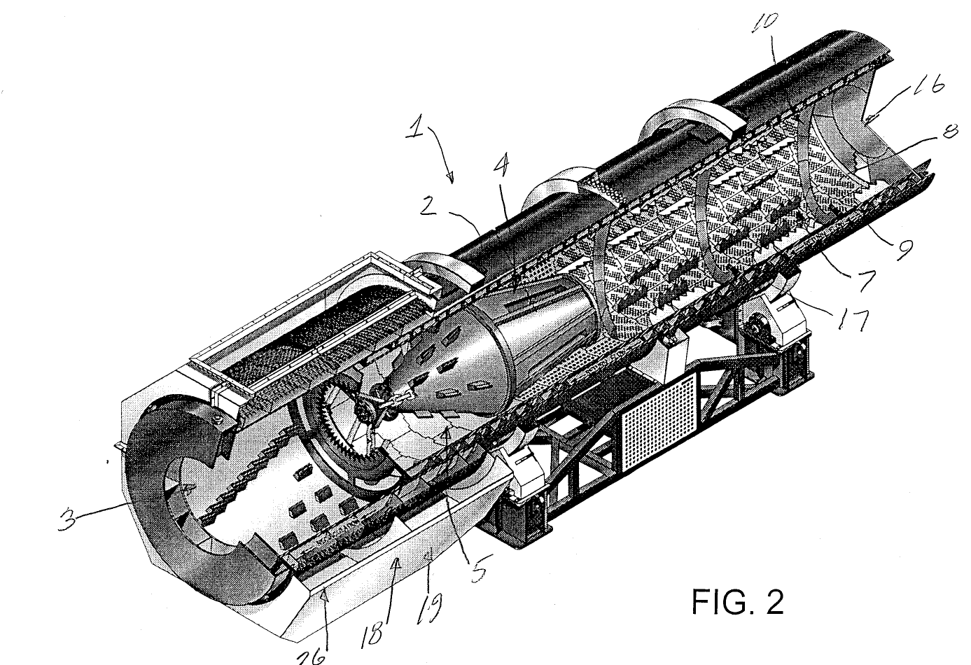

Referring now in detail to the drawings, FIG. 1 is a block flow diagram of the process for recovering a high percentage content of metal concentrates from dross in accordance with the present invention. The process utilizes a rotary lump crusher/reclaimer apparatus 1 which may be of the type shown in greater detail in FIG. 2 made by Didion Manufacturing Company of St. Peters, Mo., to mechanically separate and remove the oxide and flux salt components from the metal component while keeping the metal component in the largest particle size possible. This is because the metal, for example aluminum, is a malleable metal that can be formed into various shapes without breaking, whereas the oxides and flux salts are friable and can be crumbled or crushed to powder.

The rotary crusher/reclaimer apparatus 1 shown in FIG. 2 includes an outer cylinder 2 having an intake compartment 3 at the front end in which the dross material to be processed is fed as by means of a conveyor, shovel, load hopper, vibratory conveyor or any other suitable means that places a large amount of the dross material into the entry end of the apparatus. Intake compartment 3 contains suitable means to separate large clumps of the dross material into smaller clumps of material and convey the material into an adjacent section 4 containing crushing and grinding means 5. If any metal particles contained in the dross are too large to pass through the crusher section 4, the flow through the apparatus may be periodically reversed for a sufficient period of time to back the excessively large metal particles out of the apparatus. If upon inspection these very large metal particles are free of oxide and flux salt components, they may be fed directly into a sidewell type furnace 6, schematically shown in FIG. 1, for melting without the use of salt flux.

During passage of the remaining dross material through the crusher section 6, virtually all of the oxide and flux components are crumbled or crushed into powder and shaken off the remaining larger metal particle concentrate, but not completely off the smaller metal particles because the smaller metal particles must be impacted to a much greater degree than the larger metal particles to separate the oxide and flux components from the smaller metal particles.

Following the crusher section 4, the material enters an attrition chamber 7 where the oxide and flux components and other smaller particles that have been crushed and shaken off the larger metal particle concentrate during the tumbling and crushing process and the smaller metal particles that still have some of the oxide and flux components adhered thereto are screened off from the larger metal particle concentrate through deck holes 8 in an inner cylinder wall 9 for further processing as described hereafter.

The attrition chamber 7 may contain blades 10 to further assist in removal of the oxide and flux components from the metal particle concentrates. This larger metal particle concentrate 15 (which is free of the oxide and flux components) is removed from the back end 16 of the crusher/reclaimer apparatus 1 and may be fed directly into the sidewell type furnace 6 as schematically shown in FIG. 1 for direct melting of the larger metal particle concentrate without the use of salt flux.

The smaller particulate material that passes through the deck holes 8 into the space between the inner and outer cylinders 9 and 2 is swept forwardly toward the intake area 3 of the apparatus 1 by continuing conveyor means in the form of helical vanes 17 between the inner and outer cylinders for classification through a multiple screening system 18 having a smaller screening section 19 that separates out the oxide and flux fines from the smaller metal components. A more detailed description of the construction and operation of a rotary lump crusher/reclaimer apparatus of the type shown in FIG. 2 can be found in U.S. Pat. No. 5,974,865, assigned to Didion Manufacturing Company, the entire disclosure of which is incorporated herein by reference.

The size of the deck holes 8 in the inner cylinder portion 9 of the attrition chamber 7 may vary depending on the size of the smaller metal particles in the dross being reclaimed and the minimum size of metal particle concentrate in the dross that are freed of all of the oxide and flux components (and other foreign particles) adhered thereto during passage through the lump crusher/reclaimer apparatus.

If the dross is aluminum dross of the type described herein, the apparatus will effectively remove all of the oxide and flux components from aluminum particles in the dross having a diameter of 15 millimeters (mm) or greater. Accordingly, the deck holes may be 15 mm or larger in diameter. However, the larger the deck holes, the less percent of metal particle concentrate in the dross that would be removed from the back end of the apparatus for direct feeding into a sidewell type furnace and the greater the percent of material containing additional metal particle concentrate requiring further processing to remove the oxide and flux components therefrom as described hereafter. Accordingly, when processing aluminum dross of the type described herein, it would be preferable to make the deck holes no smaller than 15 mm and no larger than 25 mm in diameter.

The purpose of the multiple screening system 18 adjacent the front end of the apparatus is to separate out the free oxide and flux fines from the remaining smaller metal components prior to further processing of the smaller metal components to recover as much of the free metal concentrate contained therein as possible. If the dross is aluminum dross of the type described herein, most of the smaller aluminum particles contained in the dross would have a diameter of 2 mm or larger. Since the fine oxides and fluxes already removed from the aluminum particles would have a diameter less than 2 mm, the smaller particles or fines 20 having a diameter of less than 2 mm are desirably separated out from the larger particles by the smaller screening section 19 and removed from the apparatus for further processing for any remaining metal content or other by-product or placed in landfill as schematically shown in FIG. 1 depending on the economics.

The remaining smaller metal particles 25 are also removed from the apparatus 1 through another section 26 and transferred to a high velocity impactor 27, schematically shown in FIG. 1, for high speed impacting to remove all of the remaining oxide and salt components or other particles from the smaller metal particles. Then all of the material is transferred from the impactor 27 to a multiple screening system 28, also schematically shown in FIG. 1, to separate out the smaller metal particle concentrate 29 (which if aluminum has a minimum particle diameter greater than 2 mm) from the much smaller fines 30 (which have a maximum particle diameter less than 2 mm). These fines 30, along with the fines 20 removed from the rotary lump crusher/reclaimer apparatus 1, can be further processed for any remaining metal content or other by-products or placed in landfill depending on the economics. The smaller metal particle concentrate 29 obtained by this further process may then be mechanically submerged underneath the already melted large metal concentrate in the sidewell furnace 6 using a suitable submergence system such as a vortex pump or puddling to melt the additional smaller metal concentrate.

From the foregoing, it can be seen that this process can be utilized to produce concentrates of aluminum (or other metals) from dross that are in excess of 95% in recovered metal content. These concentrates can be directly melted in a reverb or sidewell type furnace without the use of salt flux, and without generating any salt cake.

Although the invention has been shown and described with respect to certain embodiments, it is obvious that equivalent alterations and modifications will occur to others skilled in the art upon the reading and understanding of the specification. In particular, with regard to the various functions performed by the above-described components, the terms (including any reference to a “means”) used to describe such components are intended to correspond, unless otherwise indicated, to any component which performs the specified function of the described component (e.g., that is functionally equivalent), even though not structurally equivalent to the disclosed component which performs the function in the herein illustrated exemplary embodiments of the invention. Also, all of the disclosed functions may be computerized and automated as desired. In addition, while a particular feature of the invention may have been disclosed with respect to only one embodiment, such feature may be combined with one or more other features as may be desired and advantageous for any given or particular application.

What is claimed is:

1. A process for increasing the percentage of metal recovery from dross containing metal particles of different sizes having oxide and salt components adhered thereto comprising the steps of crushing and tumbling the dross to mechanically remove the oxide and salt components from the larger of the metal particles, separating the larger metal particles from the removed oxide and salt components and the smaller metal particles to provide a supply of larger metal particle concentrate, separating the removed oxide and salt components from the smaller metal particles, mechanically impacting the smaller metal particles to remove additional oxide and salt components from the smaller metal particles, and separating the smaller metal particles from the additional oxide and salt components to provide a supply of smaller metal particle concentrate.

2. The process of claim 1 wherein the larger metal particle concentrate is fed into a furnace for direct melting of the larger metal particle concentrate without the use of salt flux.

3. The process of claim 2 wherein the furnace is a sidewell type furnace.

4. The process of claim 2 wherein the smaller metal particle concentrate is submersed into the melted larger metal particle concentrate to melt the smaller metal particle concentrate.

5. The process of claim 1 wherein the dross is aluminum dross and the larger metal particle concentrate has particle diameters greater than 15 mm.

6. The process of claim 5 wherein the smaller metal particles that are separated from the larger metal particles have maximum particle diameters of less than 15 mm.

7. The process of claim 5 wherein the smaller metal particles that are separated from the removed oxide and salt components have a minimum particle diameter greater than 2 mm.

8. The process of claim 7 wherein the removed oxide and salt components that are separated from the smaller metal particles have a maximum particle diameter less than 2 mm.

9. The process of claim 8 wherein the smaller metal particle concentrate has a minimum particle diameter greater than 2 mm.

10. The process of claim 9 wherein the additional oxide and salt components that are separated from the smaller metal particles after the smaller metal particles are impacted have a maximum particle diameter less than 2 mm.
